(19) United States
(12) Patent Application Publication
(10) Pub. No.: US 2015/0367760 A1
(43) Pub. Date: Dec. 24, 2015

(54) VEHICLE SEAT

(71) Applicant: TACHI-S CO., LTD., Akishima-shi, Tokyo (JP)

(72) Inventors: Kazuya IMAYOU, AKISHIMA-SHI, TOKYO (JP); Toshiki IGARASHI, AKISHIMA-SHI, TOKYO (JP); Masaaki HONDA, AKISHIMA-SHI, TOKYO (JP); Yayoi HIRANO, AKISHIMA-SHI, TOKYO (JP)

(21) Appl. No.: 14/765,934

(22) PCT Filed: Dec. 4, 2013
(86) PCT No.: PCT/JP2013/082519

§ 371 Date: Aug. 5, 2015

(30) Foreign Application Priority Data
Feb. 5, 2013 (JP) 2013-020181

(51) Int. Cl. B60N 2/28

(52) U.S. Cl. CPC B60N 2/2893

(57) ABSTRACT

A vehicle seat for use with a child seat may comprise a seatback, seat cushion, and a pair of anchors structured to hold the child seat of an ISO-FIX type. Each anchor may have a pair of left and right side bars and a front bar coupled to upper ends of the left and right side bars, and be a U-shaped form. The front bars are structured to engage with the engagement member of the child seat. The left and right side bars are secured to a bracket and extend forward obliquely from an upright position. The bracket may be secured to a connecting pipe provided in the seat cushion or the seatback and provided at a position where the engagement member abuts on the bracket when the side bars are deformed by a load transmitted to the front bar with which the engagement member is engaged.

### CROSS-REFERENCE TO RELATED APPLICATIONS

This is the U.S. national stage of application No. PCT/JP2013/082519 dated Dec. 4, 2013. Priority under 35 U.S.C. §119(a) and 35 U.S.C. §365(b) is claimed from Japanese Patent Application No. 2013-020181, filed Feb. 5, 2013, the entire contents of which are incorporated herein by reference.

### BACKGROUND OF THE INVENTION

1. Field of the Invention

This invention relates to a vehicle seat having anchors that accord with the ISO-FIX standard and can hold an ISO-FIX type child seat.

2. Description of the Related Art

The ISO-FIX standard is known as international standard of systems for holding child seats to vehicle seats. A vehicle seat is disclosed in, for example, JP 2002-211287A. The vehicle seat has anchors that accord with the ISO-FIX standard, and can hold an ISO-FIX type child seat.

The child seat of ISO-FIX type has a pair of engagement members, i.e., left and right members, at the rear part. The engagement members are fastened to anchors. The anchors may be arranged at, for example, the rear edge of the seat cushion of a vehicle seat.

An anchor is known, which has been formed by bending a wire member (or solid rod member). The anchor has a pair of side bars (i.e., left and right side bars) and a front bar. The left and right side bars extend forwards and parallel to each other. The front bar couples the left and right side bars, and the anchor is substantially U-shaped as seen in the plan view. The engagement members at the rear part of the child seat have an elongate groove in the distal end. If the distal ends of the engagement members, each having a groove, are engaged with the front bars of the anchors, the child seat will be secured to the anchors.

Two anchors are secured to a connecting pipe that extends between, for example, the rear ends of the left and right side frames of a seat cushion frame.

JP 2002-211287A describes that the rear ends of the side bars of each anchor are wound around the connecting pipe, from the upper part to rear part of the circumferential surface of the connecting pipe. The rear ends of the side bars, so wound, are covered with brackets from back to front. The rear ends of the side bars and the brackets are secured to the connecting pipe by means of welding. The front ends of the left and right side bars extend forwards from the upper part of the connecting pipe in a substantially horizontal direction, and are then coupled by the front bar.

Patent Literature: Japanese Patent unexamined Publication JP 2002-211287A

If the car is hit at the rear or makes an abrupt stop, a load will act on the child seat. The load is transmitted via the engagement members of the child seat to the front bar of each anchor. Each anchor receives the load, because of its flexural rigidity.

Each anchor has its side bars secured, at lower end, to the connecting pipe, and its front bar coupled to the front ends of the side bars, and is therefore shaped supported like a cantilever. Hence, the side bars of the anchor undergo bending deformation and are bent downwards, unless they overcome the load the anchor receives.

In the invention of JP 2002-211287A, the rear ends of the side bars of the anchor, which are wound around the connecting pipe, are covered with the bracket and secured (welded) to the connecting pipe. The rear ends of the side bars are thereby firmly fixed to the connecting pipe. However, if the car is hit at the rear or makes an abrupt stop, a large load will acts on the child seat. In this case, the anchor may be greatly bent downwards, while winding the side bars around the front part of the connecting pipe, and may be excessively deformed.

JP 2002-211287A further describes a configuration which the rear ends of the side bars are wound around the rear circumference of the connecting pipe, from the lower surface, not from the upper surface, thus covering the lower surface of either rear end of the side bars. However, excessive deformation of the anchor cannot be prevented in this configuration, either.

The anchor receives a load, because of its flexural rigidity. Hence, if it is made of a wire member having a large diameter (i.e., thick wire), it can acquire a high flexural rigidity, and its deformation can be controlled. If the anchor is made of a thick wire, however, it will inevitably become not only expensive, but also heavy.

An object of this invention is to provide a vehicle seat, in which the anchors are made of a relatively thin wire member and can yet be prevented from being excessively deformed even if they receives a large load.

### SUMMARY OF THE INVENTION

In one aspect of this invention, the side bars of each anchor extend forward obliquely from an upright position and are positioned to abut on the associated engagement member when the side bars are deformed.

In this invention according to one aspect of the embodiment of claim 1, a vehicle seat for use with a child seat having an engagement member provided on the back; the vehicle seat comprises a seatback; seat cushion; and a pair of anchors structured to hold the child seat of an ISO-FIX type, wherein each anchor has a pair of left and right side bars and a front bar coupled to upper ends of the left and right side bars, and is a U-shaped form as seen in a plan view, the front bars of the anchors are structured to engage with the engagement member provided on the back of the child seat, the left and right side bars of each anchor are secured to a bracket and extend forward obliquely from an upright position, the bracket is secured to a connecting pipe provided in the seat cushion or the seatback and extending in a direction parallel to the front bars of the anchors, and is provided at a position where the engagement member abuts on the bracket when the side bars are deformed by a load transmitted to the front bar with which the engagement member is engaged.

A load larger than usual acts on the child seat when the car is hit at the rear or makes an abrupt stop. In an embodiment of this invention, the side bars of each anchor are deformed unless the flexural rigidity of the anchor withstands the load. Since the side bars of each anchor extend forward obliquely from an upright position, however, they undergo buckling deformation and are less deformed than when they undergo bending deformation. Further, as the side bars are deformed, the engagement member moves down and abuts on the bracket. Receiving the load, the bracket prevents the engagement member form moving down further, and preventing the side bars from being deformed further. Thus, the anchors are reliably prevented from being excessively deformed, without increasing their diameter.

### BRIEF DESCRIPTION OF THE DRAWINGS

FIG. 1 is a schematic side view of a vehicle seat according to one embodiment of this invention;

FIG. 2 is a perspective view of an embodiment of the anchors and brackets used in the vehicle seat;

FIG. 3A is a partly sectional, side view of an embodiment of a child seat and one anchor having its side bars not deformed yet;

FIG. 3B is a partly sectional, side view of an embodiment of a child seat and one anchor having its side bars deformed;

FIG. 4 is a schematic side view of a vehicle seat according to another embodiment (Embodiment 2) of this invention; and

FIG. 5 is a perspective view of an embodiment of the anchors and brackets used in the vehicle seat according to another embodiment.

a vehicle seat for use with a child seat having an engagement member provided on the back; the vehicle seat comprises a seatback; seat cushion; and a pair of anchors structured to hold the child seat of an ISO-FIX type, wherein each anchor has a pair of left and right side bars and a front bar coupled to upper ends of the left and right side bars, and is a U-shaped form as seen in a plan view, the front bars of the anchors are structured to engage with the engagement member provided on the back of the child seat, the left and right side bars of each anchor are secured to a bracket and extend forward obliquely from an upright position, the bracket is secured to a connecting pipe provided in the seat cushion or the seatback and extending in a direction parallel to the front bars of the anchors, and is provided at a position where the engagement member abuts on the bracket when the side bars are deformed by a load transmitted to the front bar with which the engagement member is engaged.

### DETAILED DESCRIPTION OF THE INVENTION

### Embodiment 1

An embodiment of this invention will be described in detail, with reference to the accompanying drawings. In the drawings, arrows Fr and Rr indicate the forward and rearward directions, and arrows L and R indicate the leftward and rightward directions, with respect to the driver seated in the driver seat.

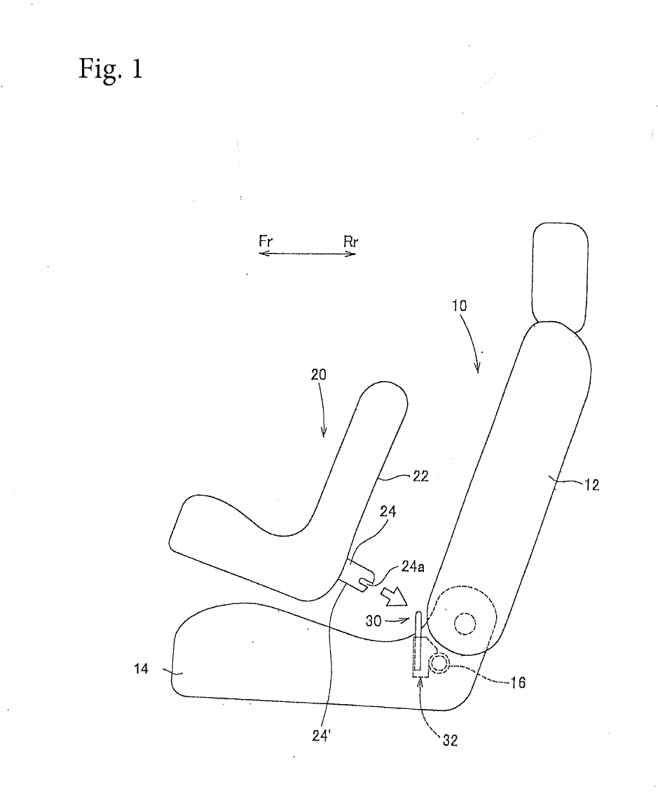

As shown in FIG. 1, an embodiments of the vehicle seat 10 has a seatback 12 and a seat cushion 14. Between the lower edge of the seatback 12 and the rear edge of the seat cushion 14, a seat reclining device (not shown) is arranged to recline the seatback to the seat cushion.

The seat cushion 14 is composed of a seat cushion frame, a pad and a trim cover. The seat cushion frame is the skeleton covered with the pad made of foamed material such as urethane foam. The pad is covered with the trim cover. The seat cushion frame comprises a pair of side frames 14f (i.e., left and right side frames), and front and rear connecting pipes extending, respectively, between the front ends of the left and right side frames 14f and between the rear ends thereof. Therefore, the side frames and the connecting pipes define a substantially rectangular frame as seen in the plan view. In FIG. 1, only the rear connecting pipe 16 is shown, which extends between the rear ends of the side frames 14f of the seat cushion 14. The connecting pipe 16 is made of a pipe member having a circular cross section, as in most cases. Nonetheless, the pipe member may have non-circular cross section.

At the rear edge of the seat cushion 14, a pair of anchors, i.e., left and right anchors 30 that accord with the ISO-FIX standard, are arranged and spaced apart from each other by a preset distance in the left-right direction of the vehicle seat 10. The anchors 30 can hold an ISO-FIX type child seat 20.

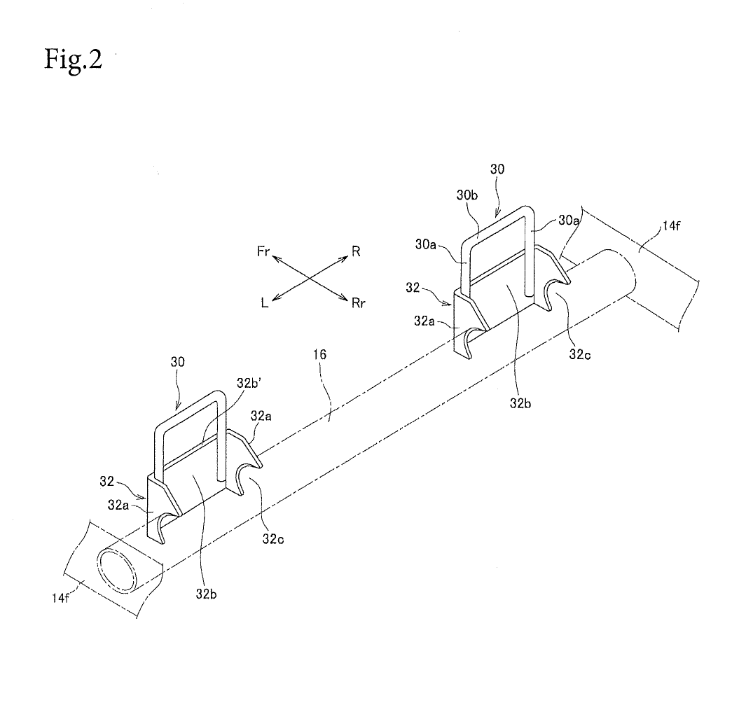

As shown in FIG. 1, the child seat 20 has a pair of engagement members 24, i.e., left and right engagement members, extending rearwards from the lower part of the back 22. Each engagement member 24 has an elongate groove 24a in the distal end. As shown in FIG. 2, the anchors 30 have been formed, each by bending a wire member. Each anchor 30 has left and right side bars 30a and a front bar 30b. The side bars 30a extend parallel to each other and forward obliquely from an upright position, and the front bar 30b couples the side bars 30a at the upper end. Hence, each anchor 30 is substantially U-shaped as seen in the plan view.

As the arrow shows in FIG. 1, the child seat 20 may be moved toward the front of the seatback 12 until the front bars 30b of the anchors 30 are engaged, respectively in the elongate grooves 24a of the left and right engagement members 24. The child seat 20 is thereby held by the anchors 30 and arranged on the seat cushion 14.

The anchors 30 are secured by brackets 32 to the connecting pipe 16 extending in the left-right direction, namely extending in a direction parallel to the front bars of the anchors, and extends forward obliquely from an upright position. Each bracket 32 has been formed by pressing a steel plate, into a member substantially U-shaped as seen in the plan view and has left and right side walls 32a and a front wall 32b connecting the side walls. The left and right side bars 30a of each anchor 30 are secured, at a lower end of the left and right side bars, to the inner surface of the associated bracket 32, by means of welding. Nonetheless, the method of securing the side bars 30a to the bracket 32 is not limited to welding.

In the embodiment, the lower ends of the side bars 30a are secured, respectively to the inner faces of the side walls 32a and the front wall 32b, at the corner parts thereof, as shown in FIG. 2. Instead, the lower ends of the side bars 30a may be secured to the inner face (back) of the front wall 32b, and spaced apart from the side walls 32a. However, if the lower ends of the side bars 30a are secured to the inner faces of the side walls 32a and the front wall 32b at the corner parts thereof, they can be welded, each to both the side wall and the front wall, and hence can be more firmly secured to the bracket 32.

The side wall 32a of each bracket 32 has, in the rear edge, a notch 32c shaped complement to the front part of the circumferential surface of the connecting pipe 16. The bracket 32 of each anchor 30 is secured, from the front, to the connecting pipe 16 and opposes the engagement member 24, with the notches 32c holding the front circumferential surface of the connecting pipe 16. At this point, the side bars 30a extend forward obliquely from an upright position. The bracket 32 is secured to the connecting pipe 16 by means of, for example, welding, so that as the side bars 30a are deformed, the side bars 30a and the engagement member 24 move down until the engaging member 24 abuts on the bracket 32.

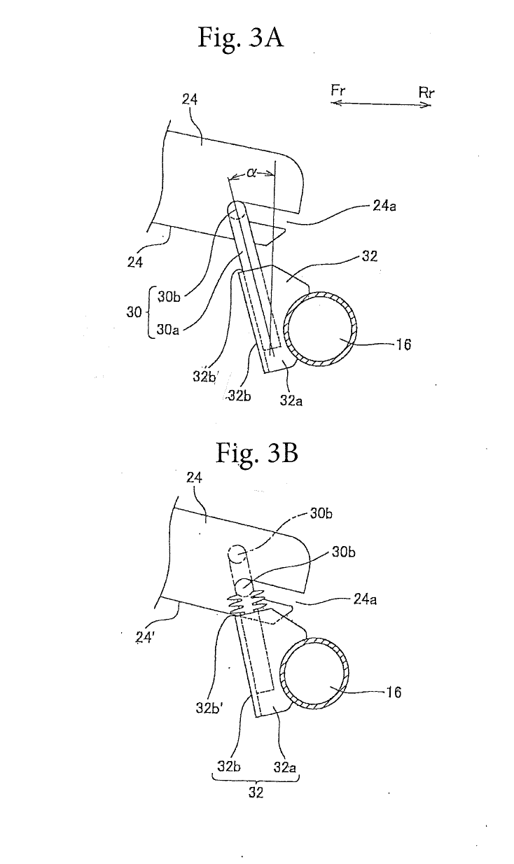

As shown in FIG. 3A, the side bars 30a of each anchor extend forward from its upright position, inclining by an angle α of 15°. The inclination angle α is not limited to 15°, nevertheless. The inclination angle α only needs to have such a value as to cause the side bars 30a to undergo buckling deformation, not bending deformation. The inclination angle α is, for example, 10 to 25°.

The upper edge 32b′ of the front wall 32b of the bracket is remoter from the connecting pipe 16 than any other parts of the bracket. This is why the bracket 32 is usually so positioned that the engagement member may abut, at lower surface 24′ of the engaging member 24, on the upper edge of the front wall as it moves down. Nonetheless, the lower surface 24′ of the engagement member does need to abut on the upper edge 32b′ of the front wall of the bracket. For example, the bracket may lie at a position (i.e., below the engagement member 24) so that the engagement member 24 may abut on it, and may be prevented from moving down further.

In most cases, the child seat 20 is held to the seat 10 not only by engaging the engagement members 24 with the anchors 30, but also by using a tether belt. The tether belt is not directly related to this invention, and is not described herein.

The grooves 24a made in the left and right engagement members 24 are elongate in the embodiment. Nonetheless, the grooves 24a are not limited to elongate ones as far as they hold the anchors 30 (more precisely, front bars 30b), securing the child seat 20 to the seat cushion 14.

If the car is hit at the rear or makes an abrupt stop, a large load will acts on the child seat 20. The load is transmitted via the engagement members 24 of the child seat to the front bars 30b of the anchors 30. The anchors 30 receive the load, because of their flexural rigidity. Each anchor has its side bars 30a secured, at rear end, to the connecting pipe 16, and its front bar 30b coupled to the front ends of the side bars. Each anchor is therefore supported like a cantilever, with its front bar 30b coupled to the front ends of the side bars. Inevitably, the anchors receive a large load and may fail to withstand the load. In this case, the anchors, more precisely the side bars, are deformed.

In this invention, however, the side bars 30a of each anchor (see FIG. 3A) extend forward obliquely from an upright position. The side bars 30a therefore undergo buckling deformation (see FIG. 3B), not bending deformation. The buckling deformation is smaller than the bending deformation.

Moreover, the engagement members 24 of the child seat, which are engaged with the front bars 30b, move down as the side bars 30a are deformed. At this point, the brackets 32 lie below the engagement members 24, and the lower surfaces 24′ of the engagement members, which are lowering, abut on the upper ends 32b′ of the front walls 32b. As a result, the brackets 32 receives the load, and prevents the engagement members 24 from lowering, thus preventing the side bars 30a from being deformed.

Hence, even if the car is hit at the rear or makes an abrupt stop, a large load acts on the child seat 20 and is then transmitted via the engagement members 24 of the anchors 30, the anchors are reliably prevented from being excessively deformed, without increasing their diameter.

Since the notches 32c holding the front circumferential surface of the connecting pipe 16 are made in the rear edges of the side walls 32a, the brackets 32 are secured (welded) to the connecting pipe 16 over a sufficiently long distance. Thus, the brackets 32 are so firmly fastened to the pipe 16 that they can withstand the load transmitted from the child seat 20 to the anchors 30.

Moreover, the front wall 32b of each bracket extends at right angles to the left-right direction in which the associated engagement member 24 extends. Hence, the lower surface 24′ of the engagement member reliably abut on the upper edge 32b′ of the front wall even if the child seat 20 shifts in the left-right direction and then mounted on the seat 10.

The side bars of each anchor are supported by the bracket, and extend forward obliquely from an upright position. The bracket is positioned to abut on the associated engagement member of the child seat when the side bars are deformed. Hence, the side bars undergo buckling deformation and are not so much deformed as they undergo bending deformation. Further, as the side bars of the anchors are deformed, the engagement members move down and abut on the brackets. Receiving a load, the brackets prevent the engagement members from moving down further, preventing the deformation of the side bars. Thus, even if a large load acts on the anchors, the anchors are reliably prevented from being excessively deformed, without increasing their diameter.

The embodiments has been described to explain this invention, and are not intended to limit the scope of the invention. Accordingly, various changes and modifications may be made within the spirit or scope of this invention, and are of course included in this invention.

In the embodiment (Embodiment 1), the anchors are provided at the seat cushion. That is, the anchors are secured by brackets to the connecting pipe extending between the rear ends of the left and right side frames 14f of the seat cushion frame. Instead, the anchors may be provided at the seatback.

### Embodiment 2

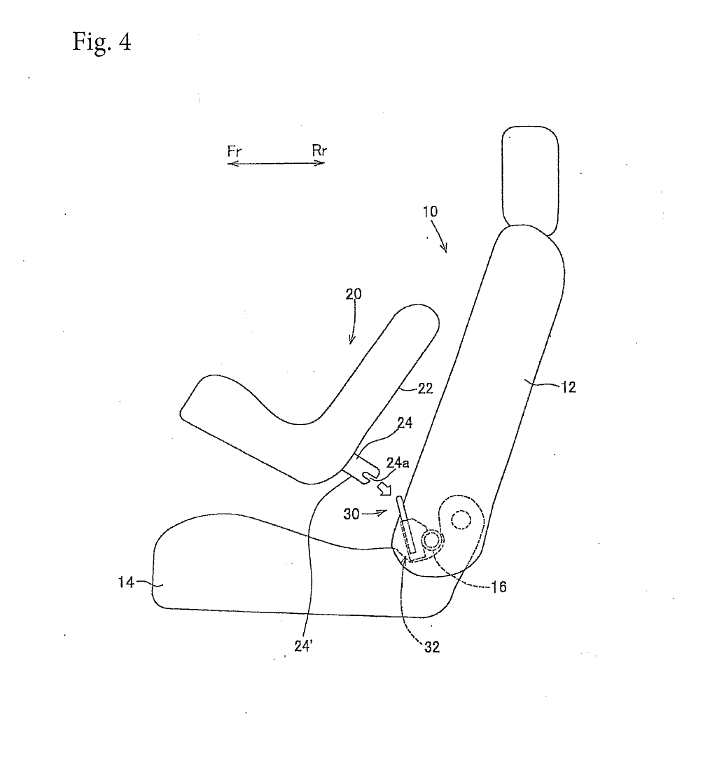

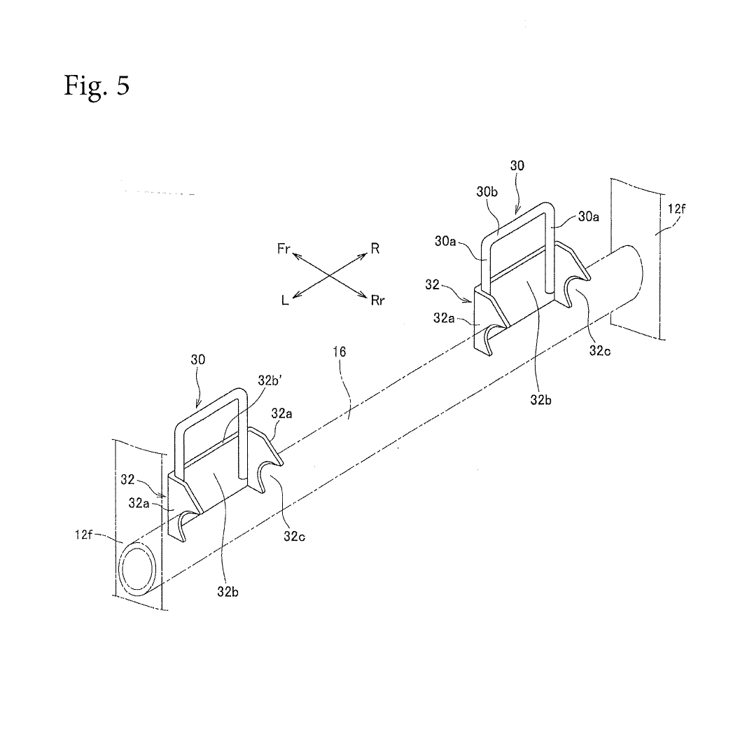

A vehicle seat according to another embodiment (Embodiment 2) of this invention will be described with reference to FIGS. 4 and 5.

The components identical to those of the embodiment (Embodiment 1) described above are designated by the same reference numbers, and will not be described. The components different from those of the above-described embodiment (Embodiment 1) will be described in the main.

Embodiment 2 shown in FIGS. 4 and 5 differs from Embodiment 1 in that the anchors 30 are provided at the seatback 12. The anchors 30 are secured by the brackets 32 to the connecting pipe 16 extending, in the left-right direction, namely extending in a direction parallel to the front bars of the anchors, between the lower ends of the left and right side frames 12f of the seatback frame.

In the embodiment 2, the side bars 30a of each anchor 30 are supported by the bracket 32, and extend forward obliquely from an upright position. The bracket 32 is positioned to abut on the associated engagement member 24 of the child seat 20 as shown in FIG. 3A when the side bars 30a are deformed. Hence, the side bars 30a undergo buckling deformation and are not so much deformed as they undergo bending deformation. Further, as the side bars 30a of the anchors 30 are deformed, the engagement members 24 move down and abut on the brackets 32 as shown in FIG. 3B. Receiving a load, the brackets 32 prevent the engagement members 24 from moving down further, preventing the deformation of the side bars 30a. Thus, even if a large load acts on the anchors 30, the anchors are reliably prevented from being excessively deformed, without increasing their diameter.

### INDUSTRIAL APPLICABILITY

This invention can be used in various types of vehicle seats having anchors for holding child seats of the ISO-FIX type.

What is claimed is:

1. A vehicle seat for use with a child seat having an engagement member provided on the back; the vehicle seat comprising:
a seatback;
a seat cushion; and
a pair of anchors structured to hold the child seat of an ISO-FIX type, wherein
each anchor has a pair of left and right side bars and a front bar coupled to upper ends of the left and right side bars, and is a U-shaped form as seen in a plan view,
the front bars of the anchors are structured to engage with the engagement member provided on the back of the child seat,
the left and right side bars of each anchor are secured to a bracket and extend forward obliquely from an upright position,
the bracket is secured to a connecting pipe provided in the seat cushion or the seatback and extending in a direction parallel to the front bars of the anchors, and is provided at a position where the engagement member abuts on the bracket when the side bars are deformed by a load transmitted to the front bar with which the engagement member is engaged.

2. The vehicle seat according to claim 1, wherein
the connecting pipe extends between rear ends of the left and right side frames of the seat cushion or between lower ends of the left and right side frames of the seatback.

3. The vehicle seat according to claim 2, wherein the bracket has a pair of left and right side walls and a front wall connecting the left and right side walls and is a U-shaped form as seen in a plan view;
the left and right side bars of each anchor are secured, at a lower end of the left and right side bars, to an inner surface of the bracket; and
the bracket is provided at a position where the engagement member abuts, at a lower surface, on an upper edge of the front wall when the side bars are deformed.

4-6. (canceled)

7. The vehicle seat according to claim 3, wherein notches structured to hold a front circumferential surface of the connecting pipe are made in rear edges of the side walls of the bracket, and the bracket is secured to the connecting pipe, while holding the connecting pipe in the notches.

8. The vehicle seat according to claim 1, wherein the bracket comprises a pair of left and right side walls and a front wall connecting the left and right side walls and is a substantially U-shaped form as seen in a plan view;
the left and right side bars of each anchor are secured, at a lower end of the left and right side bars, to an inner surface of the bracket; and
the bracket is provided at a position where the engagement member abuts, at a lower surface, on an upper edge of the front wall when the side bars are deformed.

9. The vehicle seat according to claim 1, wherein notches structured to hold a front circumferential surface of the connecting pipe are made in the rear edges of the side walls of the bracket, and the bracket is secured to the connecting pipe, while holding the connecting pipe in the notches.

10. The vehicle seat according to claim 2, wherein notches structured to hold a front circumferential surface of the connecting pipe are made in the rear edges of the side walls of the bracket, and the bracket is secured to the connecting pipe, while holding the connecting pipe in the notches.

11. The vehicle seat according to claim 8, wherein notches structured to hold a front circumferential surface of the connecting pipe are made in the rear edges of the side walls of the bracket, and the bracket is secured to the connecting pipe, while holding the connecting pipe in the notches.
